(19) United States
(12) Patent Application Publication
(10) Pub. No.: US 2026/0307467 A1
(43) Pub. Date: Oct. 8, 2026

(54) CARRIER PLATE AND WINDOW REGULATOR

(71) Applicant: HI-LEX Corporation, Hyogo (JP)

(72) Inventors: Shingo KAWAI, Hyogo (JP); Takashi YAMASHITA, Hyogo (JP)

(73) Assignee: HI-LEX Corporation, Hyogo (JP)

(21) Appl. No.: 18/998,596

(22) PCT Filed: Jul. 28, 2023
(86) PCT No.: PCT/JP2023/027684

§ 371 Date: Jan. 27, 2025

(30) Foreign Application Priority Data
Jul. 28, 2022 (JP) 2022-120825
Feb. 22, 2023 (JP) 2023-026536

(51) Int. Cl. B60J 1/17; E05F 11/48

(52) U.S. Cl. CPC B60J 1/17; E05F 11/488

(57) ABSTRACT

A carrier plate of the present invention is a carrier plate to which a window glass is attached via a holder and which slides on a guide rail, and includes: an attachment portion to which the holder is attached; a guidance portion that is provided on one side of the attachment portion and guides downward water which has fallen along a one-side edge of the holder; and a wall that is provided in a position away from the guidance portion toward a region, in which the holder is attached, by a predetermined distance and regulates an attachment position of the holder. The carrier plate is configured such that the water that has fallen along the side edge of the holder flows between the guidance portion and the wall. Such a configuration allows water, which has fallen along the side edge of the holder, to flow along a predetermined path.

### TECHNICAL FIELD

The present invention relates to a carrier plate and a window regulator.

### BACKGROUND ART

In the related art, a window regulator that pulls a carrier plate, which holds a window glass, by a cable and causes the carrier plate to slide on a guide rail to raise and lower the window glass has been used in a vehicle.

For example, Patent Literature (hereinafter referred to as “PTL”) 1 discloses a carrier plate having a drainage structure for draining water such as rainwater that has traveled along a window glass.

### CITATION LIST

### Patent Literature

PTL 1
WO 2015/064266

### SUMMARY OF INVENTION

### Technical Problem

However, in a case where a holder that holds a window glass is attached to a carrier plate, water that has fallen along a side edge of the holder from the window glass may overflow and fall downward when the position of the holder is shifted and a gap between the side edge of the holder and the carrier plate becomes small, and may come into contact with, for example, a yoke of a driving motor that is provided in a window regulator and drives a drum for winding a cable, which may cause a failure.

An object of the present invention is to provide a carrier plate and a window regulator each capable of allowing water, which has fallen along a side edge of a holder, to flow along a predetermined path.

### Solution to Problem

In order to achieve the object mentioned above, a carrier plate in the present invention is a carrier plate to which a window glass is attached via a holder and which slides on or along a guide rail. The carrier plate includes:
an attachment portion to which the holder is attached;
a guidance portion that is provided on one side of the attachment portion and guides downward water which has fallen along a one-side edge of the holder; and
a wall that is provided in a position away from the guidance portion toward a region, in which the holder is attached, by a predetermined distance and regulates an attachment position of the holder.

The carrier plate is configured such that the water that has fallen along the one-side edge of the holder flows between the guidance portion and the wall.

A window regulator in the present invention includes the carrier plate described above.

### Advantageous Effects of Invention

The carrier plate according to the present invention is capable of allowing water, which has fallen along a side edge of a holder, to flow along a predetermined path.

### BRIEF DESCRIPTION OF DRAWINGS

FIG. 1 is a front view of a window regulator according to an embodiment of the present invention;

FIG. 2 is a side view of the window regulator;

FIG. 3 is a perspective view of a carrier plate assembled to a guide rail;

FIG. 4 is an arrow view of the carrier plate as seen from the other side in the thickness direction;

FIG. 5 is an arrow view of the carrier plate as seen from the up direction;

FIG. 6 is a view illustrating a part of the structure of the carrier plate in the present embodiment;

FIG. 7 is a view illustrating a part of the structure of the carrier plate in a comparative example;

FIG. 8 is a perspective view of the carrier plate having an inclined portion;

FIG. 9 is a side view of an upper-side edge portion at which the inclined portion is formed; and

FIG. 10 is a side view of the upper-side edge portion that includes no surface substantially perpendicularly intersecting with a flat surface of the upper-side edge portion.

### DESCRIPTION OF EMBODIMENTS

### (1) Window Regulator

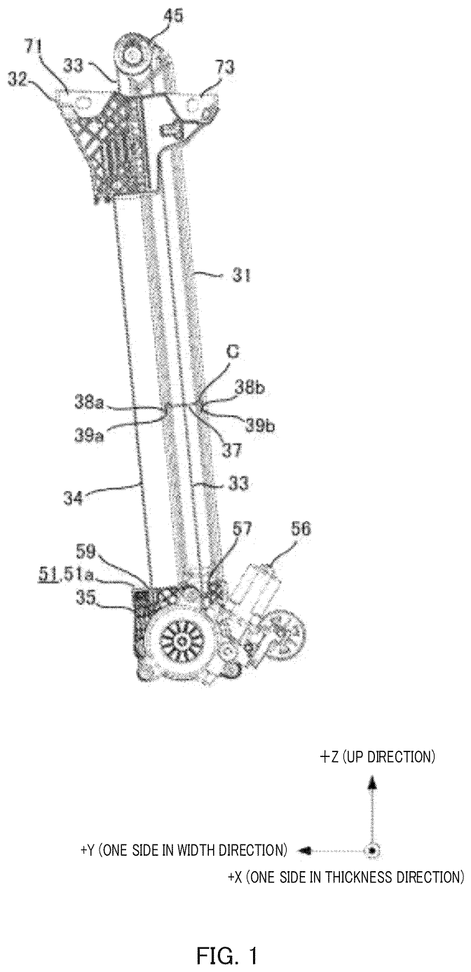

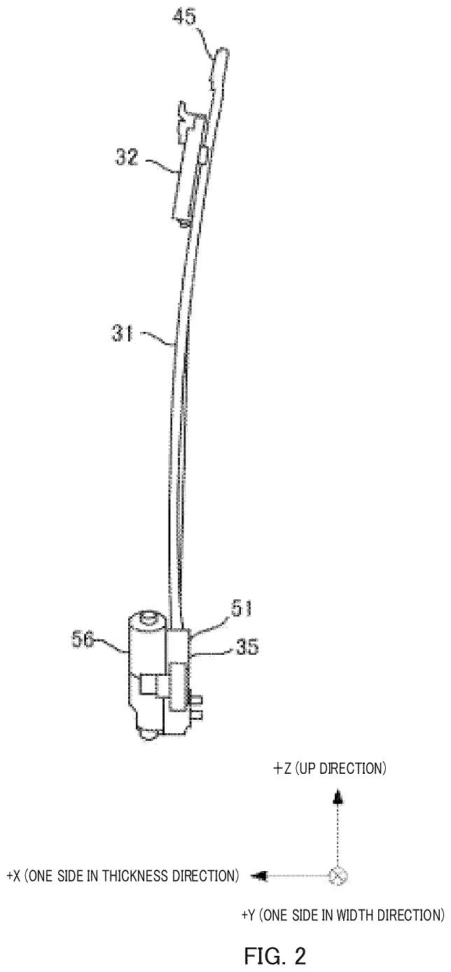

Window regulator 1 according to an embodiment of the present invention will be described with reference to FIGS. 1 and 2. FIG. 1 is a front view of a window regulator according to an embodiment of the present invention. FIG. 2 is a side view of the window regulator. Note that, in the following description, a front view of window regulator 1 will be described as a view of window regulator 1 when viewed in a plan view. FIG. 1 illustrates an X axis, a Y axis, and a Z axis. The depth direction on the paper surface of FIG. 1 will be referred to as the thickness direction or the X direction, the front side will be referred to as one side in the thickness direction or the “+X direction”, and the back side will be referred to as the other side in the thickness direction or the “−X direction”. Further, in FIG. 1, the left-right direction will be referred to as the width direction or the Y direction, the left direction will be referred to as one side in the width direction or the “+Y direction”, and the right direction will be referred to as the other side in the width direction or the “−Y direction”. Further, in FIG. 1, the up-down direction will be referred to as the length direction or the Z direction, the up direction will be referred to as the upper side or the “+Z direction”, and the down direction will be referred to as the lower side or the “−Z direction”. Note that, the raising and lowering direction of the window glass may be referred to as the up-down direction (the Z direction), the raising direction of the window glass may be referred to as the “+Z direction”, and the lowering direction of the window glass may be referred to as the “−Z direction”.

Window regulator 1 is supported by a door panel (not illustrated) of a vehicle. Window regulator 1 is a mechanism that raises and lowers a window glass (not illustrated), which is a moving object.

As illustrated in FIGS. 1 and 2, window regulator 1 mainly includes guide rail 31, carrier plate 32, raising-side cable 33, lowering-side cable 34, and driving section 35.

Guide rail 31 is a member which is provided along the raising and lowering direction (the Z direction) of the window glass and guides carrier plate 32 in the raising and lowering direction of the window glass. Guide rail 31 extends generally in the up-down direction of the vehicle (the Z direction), and is specifically configured to be inclined slightly obliquely with respect to a window glass (not illustrated) to which guide rail 31 is attached.

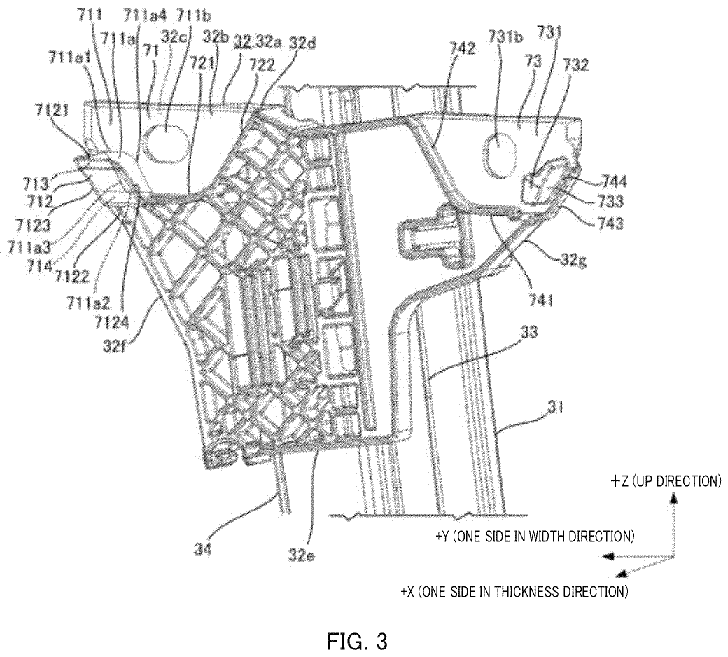

FIG. 3 is a perspective view of carrier plate 32 assembled to guide rail 31. Carrier plate 32 is a member that holds a lower end portion of the window glass and is engaged with guide rail 31 and slidingly guided in the raising and lowering direction of the window glass. Carrier plate 32 moves up and down along an edge of guide rail 31. The structure of carrier plate 32 will be described in detail later.

Upper cable guide 45 (see FIG. 1) as a direction changing member for changing the movement direction of raising-side cable 33 is provided in an upper end portion of guide rail 31.

As illustrated in FIGS. 1 and 2, driving section 35 for winding and unwinding raising-side cable 33 and lowering-side cable 34 is provided at a lower end of guide rail 31. Driving section 35 includes drum housing 51, a drum (not illustrated), and driving motor 56. Drum housing 51 is attached to a lower end portion of guide rail 31 and fixes guide rail 31 to a door panel (not illustrated) of the vehicle.

Drum housing 51 rotatably supports the drum. Driving motor 56 is integrally attached to drum housing 51 and rotationally drives the drum in both forward and reverse directions.

Raising-side cable 33 and lowering-side cable 34 are configured to pull carrier plate 32 in the up-down direction (the Z direction), and known cables formed by twisting a plurality of metal wires or resin fiber wires can be used. Raising-side cable 33 is coupled to carrier plate 32 at one end of raising-side cable 33, is wound around upper cable guide 45, and is coupled to the drum at the other end of raising-side cable 33. Lowering-side cable 34 is coupled to carrier plate 32 at one end of lowering-side cable 34 and is coupled to the drum at the other end of lowering-side cable 34.

Driving section 35 causes driving motor 56 to rotate the drum, thereby winding and unwinding raising-side cable 33 and lowering-side cable 34.

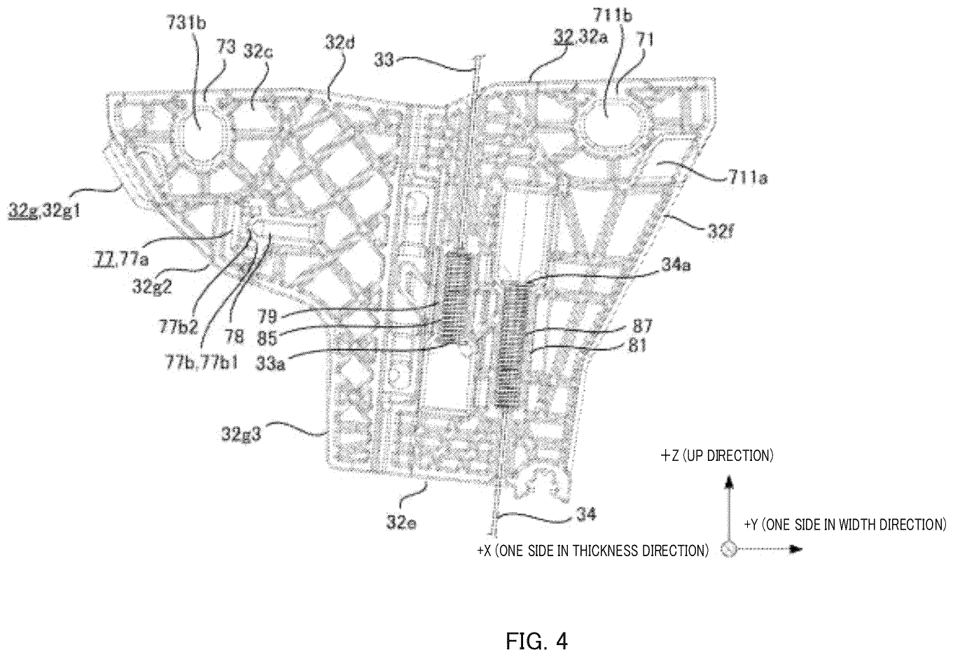

FIG. 4 is an arrow view of the carrier plate as seen from the other side in the thickness direction. Ends 33a and 34a are provided at one end of raising-side cable 33 and at one end of lowering-side cable 34, respectively. Ends 33a and 34a are formed, for example, by die casting of a metal material, and each include a base end portion to which one end of raising-side cable 33 or lowering-side cable 34 is attached, and a flange portion having an outer diameter larger than that of the base end portion. The base end portion is formed in a columnar shape or a conical trapezoid shape, and one end of raising-side cable 33 or lowering-side cable 34 is fixed to the base end portion by casting, crimping, adhesion, welding, bolting, and/or any other method.

Coil spring 85 and coil spring 87 are mounted in end 33a and end 34a, respectively. Coil spring 85 and coil spring 87 are energizing members that energize ends 33a and 34a in directions to take up the slack in raising-side cable 33 and lowering-side cable 34, respectively.

### (2) Guide Rail

Guide rail 31 is gently curved to match the curvature of the window glass of an automobile. Guide rail 31 is made of, for example, stainless steel, aluminum alloy, and/or another hard material.

FIG. 1 illustrates a front view of guide rail 31, on which cross section C, which is U-shaped, of guide rail 31 when viewed from the up direction is superimposed. Guide rail 31 includes base portion 37, sidewall portion 38a, sidewall portion 38b, flange portion 39a, and flange portion 39b. Base portion 37 has a predetermined length in the width direction (the Y direction) and extends in the up-down direction (the Z direction). Sidewall portion 38a is located at an end of base portion 37 on a side of one end in the width direction (in the +Y direction), and is erected from a long side of base portion 37 along the length direction (the Z direction) of base portion 37. Sidewall portion 38b is located at an end of base portion 37 on a side of the other end in the width direction (in the −Y direction), and is erected from the long side of base portion 37 along the length direction (the Z direction) of base portion 37.

Flange portion 39a extends, while forming a right angle with sidewall portion 38a, parallel to base portion 37 and to the side of the one end in the width direction (in the +Y direction).

Flange portion 39b extends, while forming a right angle with sidewall portion 38b, parallel to base portion 37 and to the side of the other end in the width direction (in the −Y direction).

### (3) Drum Housing

Drum housing 51 includes main body 51a (see FIG. 1) which includes a fitting portion with respect to guide rail 31 and a drum-accommodation portion having a cylindrical shape. In main body 51a, a recess having a columnar shape is formed which accommodates the drum therein. Raising-side cable lead-out groove 57 and lowering-side cable lead-out groove 59 are formed in main body 51a. Raising-side cable lead-out groove 57 and lowering-side cable lead-out groove 59 are provided respectively for allowing raising-side cable 33 and lowering-side cable 34 to pass through from the recess to lead out raising-side cable 33 and lowering-side cable 34 outside.

### (4) Structure of Carrier Plate

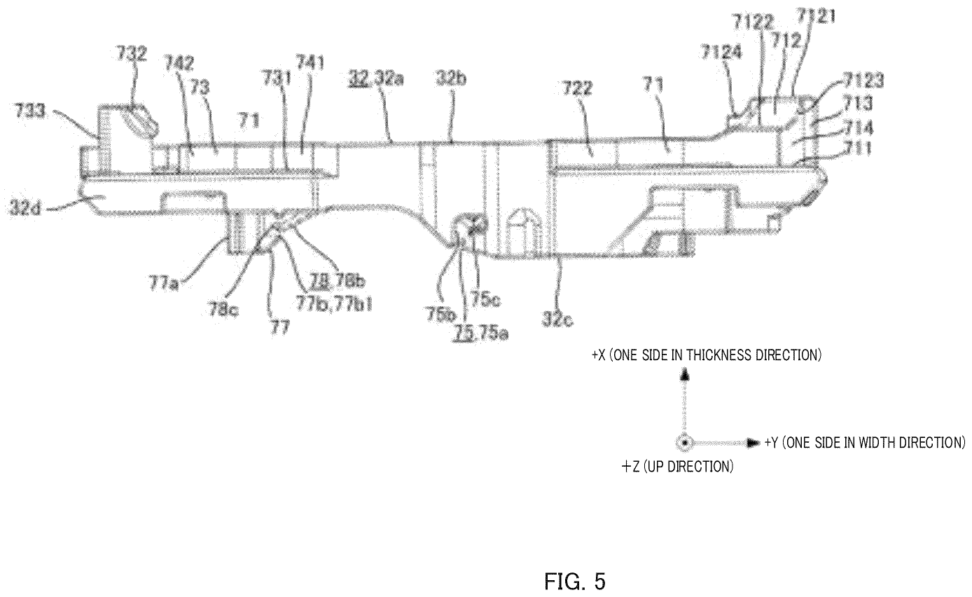

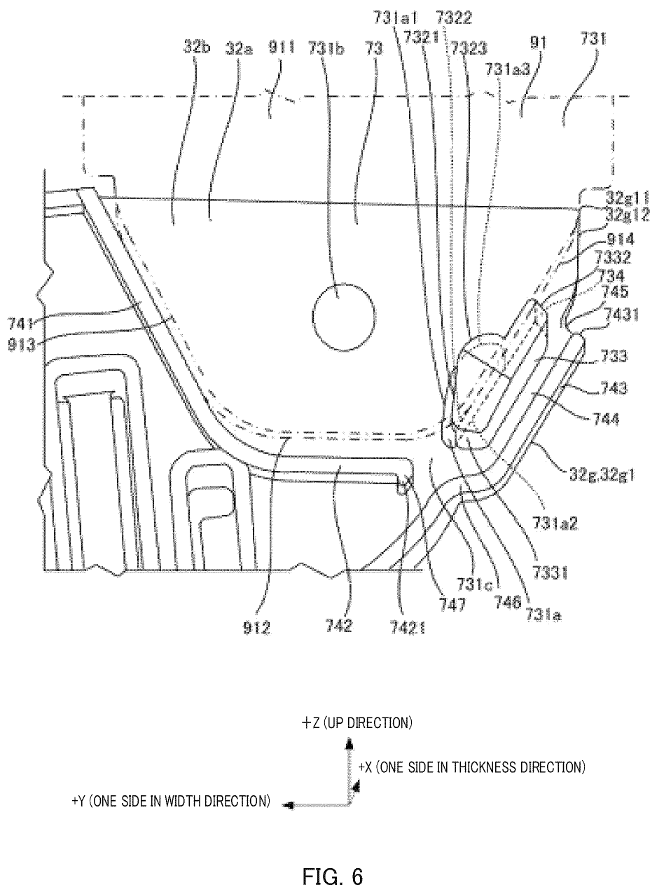

Next, the structure of carrier plate 32 in the present embodiment will be described with reference to FIGS. 4, 5, and 6. FIG. 5 is an arrow view of carrier plate 32 as seen from the up direction. FIG. 6 is a view illustrating a part of the structure of carrier plate 32 in the present embodiment.

As illustrated in FIGS. 4 and 5, carrier plate 32 includes main body 32a. Main body 32a is a base body, and may be any portion in which another structure is formed.

Main body 32a includes surface 32b, surface 32c, upper-side edge portion 32d, lower-side edge portion 32e, one-side edge portion 32f, and other-side edge portion 32g.

Surface 32b is a surface on the one side in the thickness direction (in the +X direction) of main body 32a. Surface 32c faces the other side in the thickness direction (in the −X direction).

Upper-side edge portion 32d is, among the outer peripheral edges of main body 32a, the edge that is located on the upper side (in the +Z direction) and extends from an end located on the one side in the width direction (in the +Y direction) to the other side in the width direction (in the −Y direction). Lower-side edge portion 32e is, among the outer peripheral edges of main body 32a, the edge that is located on the lower side (in the −Z direction), and extends from an end located on the one side in the width direction (in the +Y direction) to the other side in the width direction (in the −Y direction).

One-side edge portion 32f is, among the outer peripheral edges of main body 32a, the edge that is located on the one side in the width direction (in the +Y direction), and extends in an oblique direction from an end located on the upper side (in the +Z direction) to the other side in the width direction (in the −Y direction) with respect to the down direction (the −Z direction).

Other-side edge portion 32g is, among the outer peripheral edges of main body 32a, the edge that is located on the other side in the width direction (in the −Y direction), and extends in an oblique direction from an end located on the upper side (in the +Z direction) to the one side in the width direction (in the +Y direction) with respect to the down direction (the −Z direction). In other-side edge portion 32g, an edge portion located on the upper side (in the +Z direction), an edge portion located in a center portion in the up-down direction (the Z direction), and an edge portion located on the lower side (in the −Z direction) will be referred to as edge portion 32g1, edge portion 32g2, and edge portion 32g3, respectively.

As illustrated in FIGS. 3 to 5, attachment portions 71 and 73 are provided on a side of surface 32b. Holder 91 (see FIG. 6) for holding a window glass (not illustrated) is attached to attachment portions 71 and 73. Holder 91 has a plate shape with a predetermined thickness, and attachment portions 71 and 73 are configured to have an outer shape corresponding to the holder to be attached thereto, and, in the present embodiment, have an outer shape of an inverted trapezoid shape. Among the peripheral edges of the inverted trapezoid shape illustrated in FIG. 6, the peripheral edge located on the upper side (in the +Z direction), the peripheral edge located on the lower side (in the −Z direction), the peripheral edge located on the one side in the width direction (in the +Y direction), and the peripheral edge located on the other side in the width direction (in the −Y direction) will be referred to as upper-side peripheral edge 911, lower-side peripheral edge 912, one-side peripheral edge 913, and other-side peripheral edge 914, respectively, as illustrated in FIG. 6. Note that, attachment portions 71 and 73 will be described in detail later.

As illustrated in FIGS. 4 and 5, each of guide groove 75, rotation prevention claw 77, elastic claw 78, raising-side end holder 79, and lowering-side end holder 81 is provided on a side of surface 32c.

Guide groove 75 is disposed in a center portion in the width direction (the Y direction). Guide groove 75 is a groove for sliding sidewall portion 38a (see FIG. 1) and flange portion 39a (see FIG. 1) of guide rail 31. Sidewall portion 38a and flange portion 39a have an L-shaped cross-sectional shape in the XY plane. Thus, rattling of a center portion of carrier plate 32 located in the center thereof in the width direction is less likely to occur in the thickness direction (the X direction) and the width direction (the Y direction) with respect to sidewall portion 38a and flange portion 39a.

Rotation prevention claw 77 is disposed on the other side in the width direction (in the −Y direction) with respect to guide groove 75. Rotation prevention claw 77 prevents carrier plate 32 from rotating around guide groove 75. Elastic claw 78 is disposed between guide groove 75 and rotation prevention claw 77 in the width direction (the Y direction). Elastic claw 78 extends in an oblique direction from surface 32c provided in main body 32a on the other side in the thickness direction (in the −X direction) to the other side in the width direction (in the −Y direction) with respect to the other side in the thickness direction (the −X direction).

Elastic claw 78 has elasticity. Thus, elastic claw 78 has, for example, a restoring force to return to the other side in the thickness direction (in the −X direction) in a case where elastic claw 78 is bent to the one side in the thickness direction (in the +X direction) by an external force or the like. Elastic claw 78 is in contact with a surface of flange portion 39a, which is located on the one side in the thickness direction (in the +X direction). Further, rotation prevention claw 77 is in contact with a surface of flange portion 39a, which is located on the other side in the thickness direction (in the −X direction). Thus, rattling of the end portion of carrier plate 32 on the other side in the width direction (in the −Y direction) is less likely to occur in the thickness direction (the X direction) with respect to flange portion 39a.

That is, in a state in which carrier plate 32 is assembled to guide rail 31, guide groove 75 slides flange portion 39a provided in guide rail 31. The groove (gap) provided between rotation prevention claw 77 and elastic claw 78 slides flange portion 39b provided in guide rail 31.

### Details of Attachment Portion 71

Next, details of attachment portion 71 to which holder 91 is attached will be described with reference to FIGS. 3 and 5. Attachment portion 71 is disposed in a region of surface 32b on the one side in the width direction (in the +Y direction) and on the upper side (in the +Z direction).

Attachment portion 71 includes walls 711, 712, 713, and 714 and bead portions 721 and 722.

Wall 711 is a wall that extends along the YZ plane and includes hole 711a and hole 711b.

Hole 711a is a hole which is located on the one side in the width direction (in the +Y direction) and on the lower side (in the −Z direction) in the region in which attachment portion 71 is disposed, penetrates wall 711 in the thickness direction (the X direction), and has a predetermined inner peripheral shape. Among the peripheral edges of hole 711a, the peripheral edge located on the upper side (in the +Z direction), the peripheral edge located on the lower side, the peripheral edge located on the one side in the width direction, and the peripheral edge located on the other side in the width direction (in the −Y direction) will be referred to as upper-side peripheral edge 711a1, lower-side peripheral edge 711a2, one-side peripheral edge 711a3, and other-side peripheral edge 711a4, respectively.

Hole 711b is a hole which is located substantially in the center of the region in which attachment portion 71 is disposed, and penetrates wall 711 in the thickness direction (the X direction), and through which a bolt (not illustrated) for fastening holder 91 to wall 711 is inserted.

Wall 712 is a wall which is disposed away from wall 711 to the one side in the thickness direction (in the +X direction) by a predetermined length (a length corresponding to the thickness of holder 91), extends along the YZ plane, and has an outer peripheral shape corresponding to the inner peripheral shape of hole 711a. Among the peripheral edges of wall 712, the peripheral edge located on the upper side (in the +Z direction), the peripheral edge located on the lower side, the peripheral edge located on the one side in the width direction, and the peripheral edge located on the other side in the width direction (in the −Y direction) will be referred to as upper-side peripheral edge 7121, lower-side peripheral edge 7122, one-side peripheral edge 7123, and other-side peripheral edge 7124, respectively.

Wall 713 is a wall that is erected from one-side peripheral edge 711a3 toward one-side peripheral edge 7123 so as to close a gap between one-side peripheral edge 711a3 and one-side peripheral edge 7123.

Wall 714 is a wall that is erected from lower-side peripheral edge 711a2 toward lower-side peripheral edge 7122 so as to close a gap between lower-side peripheral edge 711a2 and lower-side peripheral edge 7122.

Bead portion 721 is a protruding portion that extends from an end of wall 714, which is located on the other side in the width direction (in the −Y direction), to the other side in the width direction, and protrudes from a side of wall 711 toward the one side in the thickness direction (in the +X direction).

Bead portion 722 is a protruding portion that extends in an oblique direction from an end of bead portion 721, which is located on the other side in the width direction (in the −Y direction), to the other side in the width direction with respect to the up direction (the +Z direction), and protrudes from a side of wall 711 toward the one side in the thickness direction (in the +X direction).

As described above, each of wall 711 and wall 712 is a wall that extends along the YZ plane, and wall 712 is disposed away from wall 711 to the one side in the thickness direction (in the +X direction) by a predetermined length (a length corresponding to the thickness of holder 91). Thus, each of wall 711 and wall 712 restricts the movement of holder 91 (window glass) in the thickness direction (the X direction).

Each of wall 713, wall 714, bead portion 721, and bead portion 722 has a shape corresponding to the shape of one-side peripheral edge 913, lower-side peripheral edge 912, and other-side peripheral edge 914 of holder 91 as illustrated in FIG. 6, in a plan view from the one side in the thickness direction (the +X direction). Thus, each of wall 713, wall 714, bead portion 721, and bead portion 722 restricts the movement of holder 91 (window glass) in the width direction (the Y direction) and also restricts the movement of holder 91 (window glass) to the lower side (in the-Z direction).

### Details of Attachment Portion 73

Next, details of attachment portion 73 to which holder 91 is attached will be described with reference to FIGS. 3, 5, and 6. Attachment portion 73 is disposed in a region of surface 32b on the other side in the width direction (in the −Y direction) and on the upper side (in the +Z direction).

Attachment portion 73 includes walls 731, 732, and 733, bead portions 741 and 742, and guidance portion 743.

Wall 731 is a wall that extends along the YZ plane and includes hole 731a and hole 731b.

As illustrated in FIG. 6, hole 731a is a hole that is located on the other side in the width direction (in the −Y direction) and on the lower side (in the −Z direction) in the region in which attachment portion 73 is disposed, penetrates wall 731 in the thickness direction (the X direction), and has a predetermined inner peripheral shape. The inner peripheral shape is a fan shape, and among the edges of the fan shape, the straight line-shaped edge located on the one side in the width direction (in the +Y direction), the straight line-shaped edge located on the other side in the width direction (in the −Y direction), and the arc-shaped edge located on the upper side (in the +Z direction) will be referred to as edge 731a1, edge 731a2, and edge 731a3, respectively.

Hole 731b is a hole which is located substantially in the center of the region in which attachment portion 73 is disposed, penetrates wall 731 in the thickness direction (the X direction), and through which a bolt (not illustrated) for fastening holder 91 to wall 731 is inserted.

Wall 732 is a wall which is disposed away from wall 731 to the one side in the thickness direction (in the +X direction) by a predetermined length (a length corresponding to the thickness of holder 91), extends along the YZ plane, and has an outer peripheral shape corresponding to the inner peripheral shape of hole 731a. In the outer shape, the edge corresponding to edge 731a1, the edge corresponding to edge 731a2, and the edge corresponding to edge 731a3 will be referred to as edge 7321, edge 7322, and edge 7323, respectively.

Wall 733 is a wall that is erected from edge 731a2 toward edge 7322 so as to close a gap between edge 731a2 and edge 7322. Wall 733 has a predetermined thickness in the width direction (the Y direction) and extends in an oblique direction toward the one side in the width direction (in the +Y direction) with respect to the down direction (the −Z direction). End 7331 of wall 733, which is located in the down direction, is extended to the same position as the respective ends of edge 731a2 and edge 7322, which are located in the down direction. End 7332 of wall 733, which is located in the up direction (the +Z direction), is extended in an oblique direction to the other side in the width direction (in the −Y direction) with respect to the up direction, more than the respective ends of edge 731a2 and edge 7322, which are located in the up direction.

End 7332 includes inclined surface 734 that is inclined toward the other side in the width direction (in the −Y direction) with respect to the down direction (the −Z direction). In other words, inclined surface 734 is inclined toward a side of guidance portion 743, which is the other side in the width direction (the −Y direction).

Bead portion 741 is a protruding portion that extends obliquely from an end of wall 731, which is located on the one side in the width direction (in the +Y direction) and in the up direction (the +Z direction), to the other side in the width direction (in the −Y direction) with respect to the down direction (the −Z direction), and protrudes from a side of wall 731 toward the one side in the thickness direction (in the +X direction).

Bead portion 742 is a protruding portion which extends from an end of bead portion 741, which is located on the other side in the width direction (in the −Y direction), to the other side in the width direction, includes end 7421 that extends, and protrudes from a side of wall 731 toward the one side in the thickness direction (in the +X direction).

As described above, each of wall 731 and wall 732 is a wall that extends along the YZ plane, and wall 732 is disposed away from wall 731 to the one side in the thickness direction (in the +X direction) by a predetermined length (a length corresponding to the thickness of holder 91). Thus, each of wall 731 and wall 732 restricts the movement of holder 91 (window glass) in the thickness direction (the X direction).

Each of wall 733, bead portion 741, and bead portion 742 has a shape corresponding to the shape of one-side peripheral edge 913, lower-side peripheral edge 912, and other-side peripheral edge 914 of holder 91 in a plan view from the one side in the thickness direction (the +X direction). Thus, each of wall 733, bead portion 741, and bead portion 742 restricts the movement of holder 91 (window glass) in the width direction (the Y direction) and also restricts the movement of holder 91 (window glass) to the lower side (in the −Z direction). In other words, each of wall 733, bead portion 741, and bead portion 742 regulates the attachment position of holder 91.

Bead portion 741 and bead portion 742 guide downward water that has fallen along one-side peripheral edge 913 of holder 91.

The structure of carrier plate 32 in the present embodiment allows water, which has fallen along one-side peripheral edge 913, to flow along a predetermined path.

Guidance portion 743 is disposed in edge portion 32g1 of other-side edge portion 32g, which is located on the upper side (in the +Z direction). End 32g11 of edge portion 32g1, which is located in the up direction (the +Z direction), overlaps with other-side peripheral edge 914 of holder 91 in a plan view from the thickness direction (the X direction). Side edge 32g12 of edge portion 32g1 extends in the down direction (the −Z direction) from end 32g11 toward guidance portion 743, and is connected to end 7431 of guidance portion 743, which is located on the upper side (in the +Z direction). Thus, water that has fallen along other-side peripheral edge 914 flows down along side edge 32g12. That is, side edge 32g12 constitutes a predetermined path. Guidance portion 743 guides water, which flows down along side edge 32g12, further downward.

Guidance portion 743 is a flange that is erected from a side of wall 731 toward the one side in the thickness direction (in the +X direction). Guidance portion 743 is disposed in a position away from wall 733 to the other side in the width direction (in the −Y direction) by a predetermined distance. Guidance portion 743 extends in an oblique direction from end 7431, which is located in the up direction (the +Z direction), to the one side in the width direction (in the +Y direction) with respect to the down direction (the −Z direction). As described above, wall 733 extends in an oblique direction to the one side in the width direction (in the +Y direction) with respect to the down direction (the −Z direction). Thus, flow path 744 having a predetermined width is formed between wall 733 and guidance portion 743. Flow path 744 causes water, which has fallen along side edge 32g12, to flow between wall 733 and guidance portion 743. That is, flow path 744 constitutes a predetermined path.

Side edge 32g12 is provided with notch 745, which is obtained by cutting out, in a position of flow path 744 on the upstream side (in the up direction), a part of flow path 744 in an arc shape, where water flows down through the part.

Guidance portion 743 includes outlet formation portion 746 bent from the other side in the width direction (the −Y direction), in a position in the down direction (in the-Z direction) away from end 7331 of wall 733, which is located in the down direction, by a predetermined distance. Guidance portion 743 extends in an oblique direction from a position, in which outlet formation portion 746 is disposed, to the one side in the width direction (in the +Y direction) with respect to the down direction (the −Z direction).

End 7421 of bead portion 742 is bent in the down direction (the −Z direction). End 7421 includes outlet formation portion 747. Outlet formation portion 747 is disposed in a position away from outlet formation portion 746 to the one side in the width direction (in the +Y direction) by a predetermined distance.

Wall 733 includes joining region 731c, which is partially surrounded by end 7421 (outlet formation portion 747) of bead portion 742, end 7331 of wall 733, which is located in the down direction (the −Z direction), and outlet formation portion 746 of guidance portion 743.

With the above configuration, water that has fallen along other-side peripheral edge 914 of holder 91 flows along side edge 32g12, guidance portion 743, and flow path 744, joins in joining region 731c, and flows down through a gap (outlet) provided between outlet formation portion 746 and outlet formation portion 747. That is, side edge 32g12, guidance portion 743, flow path 744, joining region 731c, and the gap (outlet) serve as a predetermined path. Further, water that has fallen along one-side peripheral edge 913 of holder 91 flows along bead portion 741 and bead portion 742, joins in joining region 731c, and flows down through the gap (outlet). That is, bead portion 741, bead portion 742, and the gap (outlet) serve as a predetermined path. Thus, it becomes easier to cause rainwater, which has fallen along one-side peripheral edge 913 and/or other-side peripheral edge 914, to flow along a predetermined path, and thus, for example, rainwater hardly comes into contact with a yoke of driving motor 56. Specifically, water that has flowed down through the gap (outlet) is guided along the walls provided at 32g and 32e to the one side in the width direction, and is discharged to the side opposite to the side, on which yoke of driving motor 56 is provided, over guide rail 31.

### Comparative Example

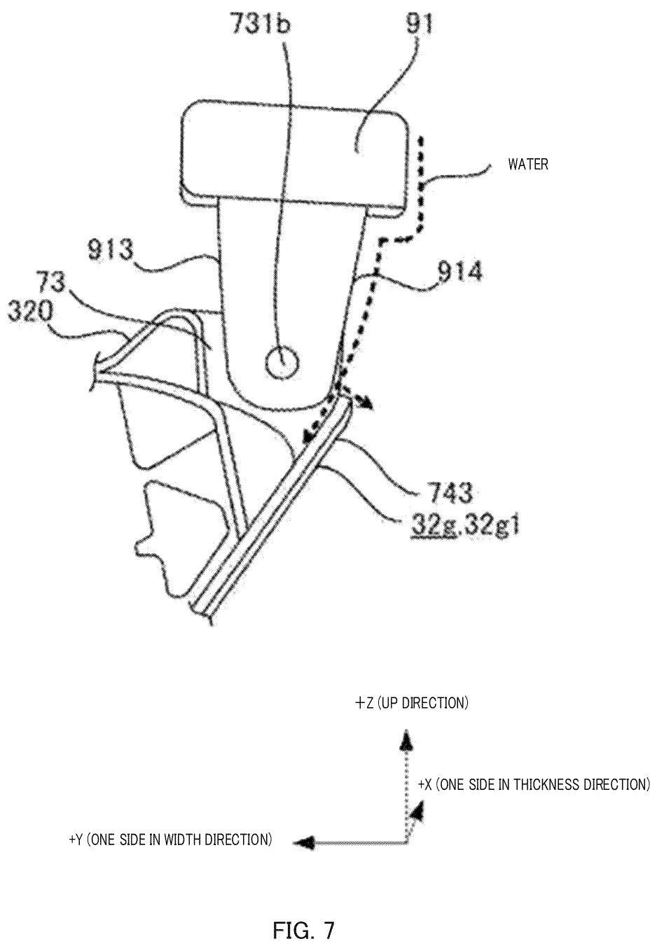

Next, the structure of carrier plate 320 in a comparative example will be described with reference to FIG. 7. FIG. 7 is a view illustrating a part of the structure of carrier plate 320 in a comparative example. In the description of the comparative example, configurations different from those in the present embodiment will be mainly described, and the same configurations will be denoted with the same reference signs and descriptions thereof will be omitted.

Carrier plate 32 in the present embodiment illustrated in FIG. 6 includes wall 733. In contrast, carrier plate 320 in the comparative example does not include wall 733.

Further, wall 733 in the present embodiment is away from guidance portion 743 to the one side in the width direction (in the +Y direction) by a predetermined distance, and flow path 744 is formed between wall 733 and guidance portion 743. In contrast, carrier plate 320 in the comparative example includes guidance portion 743, but does not include wall 733, and flow path 744 is not formed, either.

As described above, in carrier plate 320 in the comparative example, as illustrated in FIG. 7, part of rainwater that has fallen along other-side peripheral edge 914 of holder 91 does not enter guidance portion 743 and falls from carrier plate 320 to the other side in the width direction (in the −Y direction).

In contrast, since flow path 744 is formed in carrier plate 32 in the present embodiment, it is possible to cause rainwater, which has fallen along other-side peripheral edge 914, to flow along flow path 744. In the related art, when the attachment position of holder 91 is toward to the other side in the width direction, the flow path becomes narrow, and rainwater overflows from the flow path. In the present embodiment, on the other hand, it is possible to secure the flow path without fail by positioning holder 91, which makes it possible to prevent rainwater from overflowing.

Further, carrier plate 32 in the present embodiment includes bead portion 741 and bead portion 742. In contrast, carrier plate 320 in the comparative example does not include bead portion 741 and bead portion 742.

Thus, carrier plate 320 in the comparative example does not allow rainwater, which has fallen along one-side peripheral edge 913 of holder 91, to flow along a predetermined path. In contrast, carrier plate 32 in the present embodiment includes bead portion 741 and bead portion 742, and thus, allows rainwater, which has fallen along one-side peripheral edge 913, to flow along a predetermined path.

Note that, as illustrated in FIG. 3, upper-side edge portion 32d of carrier plate 32 in the above embodiment is a substantially horizontal surface, but an inclined portion that is inclined toward the side on which guidance portion 743 is provided may be provided in upper-side edge portion 32d.

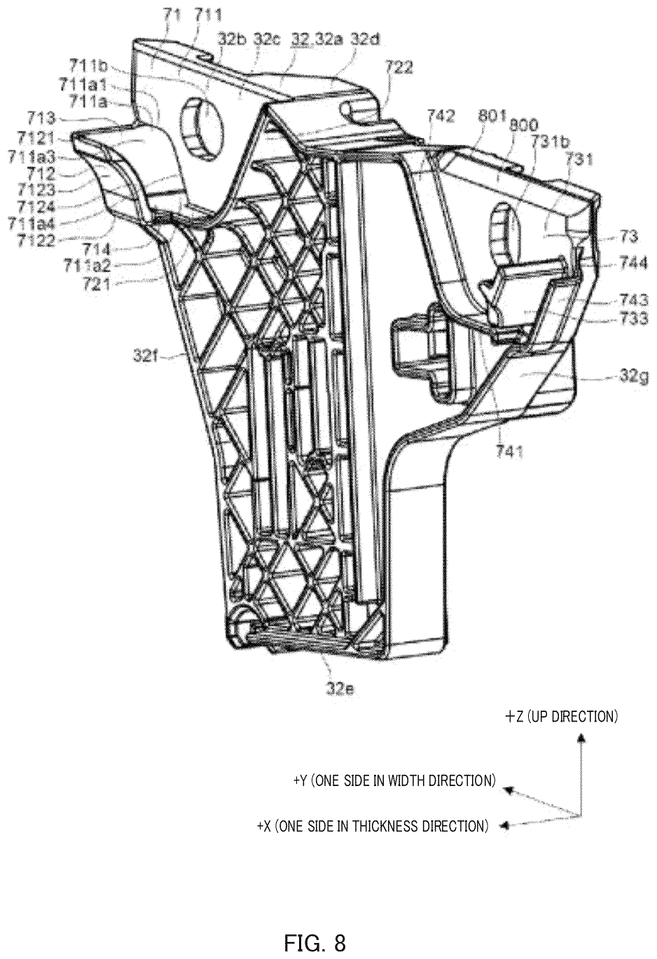

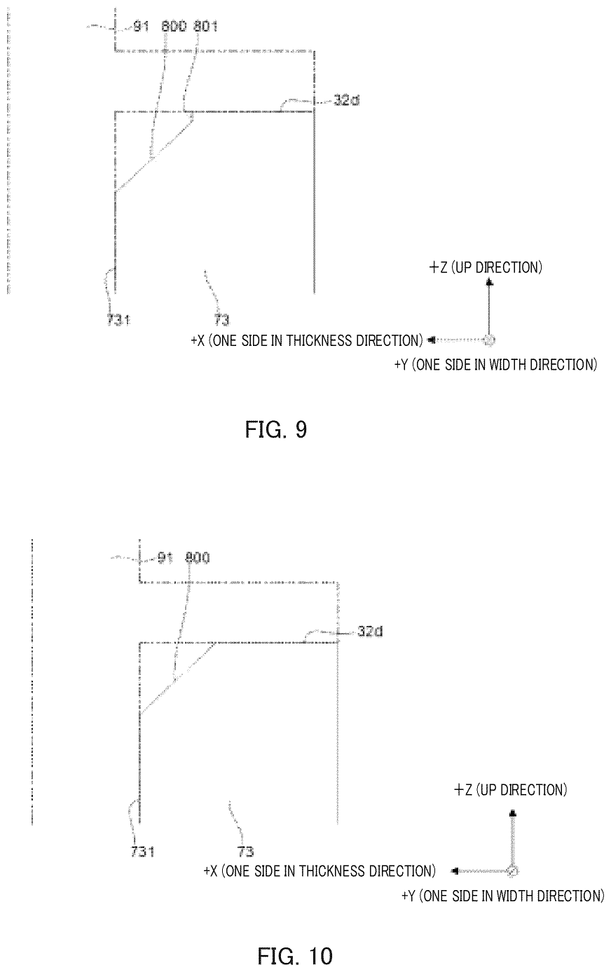

Hereinafter, the inclined portion will be described in detail with reference to FIGS. 8 to 10. FIG. 8 is a perspective view of carrier plate 32 including inclined portion 800. FIG. 9 is a side view of upper-side edge portion 32d at which inclined portion 800 is formed. FIG. 9 is a view of upper-side edge portion 32d as seen from the other side in the width direction of carrier plate 32 (the Y direction).

As illustrated in FIGS. 8 and 9, inclined portion 800, and surface 801 provided between inclined portion 800 and a flat surface of upper-side edge portion 32d are formed in upper-side edge portion 32d of carrier plate 32.

Upper-side edge portion 32d is an end portion on the side, on which a window glass is disposed, in attachment portion 73 to which holder 91 is attached as illustrated in FIG. 6. Further, surface 801 is a surface that substantially perpendicularly intersects with the flat surface of upper-side edge portion 32d on one side of the surface and intersects with inclined surface 800 on the other side of the surface.

Further, the flat surface of upper-side edge portion 32d is a surface on which a part of holder 91 is placed. FIG. 9 illustrates holder 91, which is placed on the flat surface of upper-side edge portion 32d, with a dotted line.

By providing upper-side edge portion 32d with inclined portion 800 that is inclined toward the side on which guidance portion 743 is provided, it is possible to cause water, which has fallen along the surface of holder 91, to flow along the predetermined path formed by bead portions 741 and 742, and guidance portion 743.

Further, by providing upper-side edge portion 32d with a flat surface on which a part of holder 91 is placed, carrier plate 32 can stably support holder 91.

Note that, when holder 91 holding a window glass is attached to carrier plate 32 from the upper side (the +Z direction), carrier plate 32 is located in an intermediate portion of guide rail 31.

In this case, a portion of carrier plate 32 on the left side (in the +Y direction) of guide rail 31, as illustrated in FIG. 1, is pulled to the back side (in the −X direction) of the paper surface by raising-side cable 33, and carrier plate 32 rotates counterclockwise when viewed from the lower side (the −Z direction), with a portion, at which guide rail 31 fits with guide groove 75 (see FIG. 5), as an axis.

For this reason, attachment portion 71 on the left side (in the +Y direction) of carrier plate 32 moves to the back side (in the X direction) of the paper surface, and attachment portion 73 on the right side (in the Y direction) moves to the front side (in the +X direction) of the paper surface.

In such a situation, when holder 91 is attempted to be attached to attachment portion 73 of carrier plate 32 from the upper side (the +Z direction), the bottom portion of holder 91 comes into contact with upper-side edge portion 32d of carrier plate 32, which makes it difficult to attach holder 91.

In contrast, when upper-side edge portion 32d is provided with inclined portion 800, the bottom portion of holder 91 is smoothly guided to a predetermined position of attachment portion 73 of carrier plate 32 by inclined portion 800, and thus, even when carrier plate 32 rotates, the attachment of holder 91 is facilitated.

Further, as illustrated in FIG. 9, by forming surface 801 that substantially perpendicularly intersects with the flat surface of upper-side edge portion 32d, it is possible to guide the bottom portion of holder 91 to the predetermined position of attachment portion 73 of carrier plate 32 more smoothly via inclined portion 800 while preventing the area of the flat surface of upper-side edge portion 32d and the area of inclined portion 800 from being reduced.

Further, in FIGS. 8 and 9, a case where surface 801 is formed in upper-side edge portion 32d of carrier plate 32 has been described, but surface 801 is not necessarily required. FIG. 10 is a side view of upper-side edge portion 32d that includes no surface 801 substantially perpendicularly intersecting the flat surface of upper-side edge portion 32d. FIG. 10 is a view of upper-side edge portion 32d as seen from the other side in the width direction of carrier plate 32.

Inclined portion 800 illustrated in FIG. 10 intersects with the flat surface of upper-side edge portion 32d on one side of inclined portion 800, and intersects with wall 731 of attachment portion 73 on the other side of inclined portion 800.

Even with such a configuration, it is possible to cause water, which has fallen along the surface of holder 91, to flow along the predetermined path formed by bead portions 741 and 742, and guidance portion 743. Further, even when carrier plate 32 rotates with guide rail 31 as an axis, the attachment of holder 91 is facilitated.

Further, in FIGS. 8 to 10, a case where inclined portion 800 is provided in upper-side edge portion 32d on the side of attachment portion 73 of attachment portions 71 and 73 has been described, but the same inclined portion may be provided in upper-side edge portion 32d on the side of attachment portion 71. Further, the same inclined portion may be provided in both upper-side edge portion 32d on the side of attachment portion 71 and upper edge portion 32d on the side of attachment portion 73.

However, since carrier plate 32 rotates counterclockwise when viewed from the lower side (the −Z direction) with guide rail 31 as an axis as described above, it is desirable to provide inclined portion 800 in upper-side edge portion 32d on the side of at least attachment portion 73.

Further, in FIGS. 8 to 10, a case where inclined portion 800 is a flat surface has been described, but inclined portion 800 may be a convex surface or a concave surface. In this respect, when inclined portion 800 is configured as a flat surface or a concave surface, the bottom portion of holder 91 can be stably guided to a predetermined position of attachment portion 73 of carrier plate 32, which is more preferable.

Carrier plate 32 in the present embodiment described above is a carrier plate to which a window glass is attached via holder 91 and which slides on guide rail 31, and includes: attachment portion 73 to which holder 91 is attached; guidance portion 743 that is provided on the other side of attachment portion 73 and guides downward water which has fallen along other-side peripheral edge 914 of holder 91; and wall 733 that is provided in a position away from guidance portion 743 to the one side in the width direction (in the +Y direction) by a predetermined distance and regulates an attachment position of holder 91, and carrier plate 32 is configured such that the water that has fallen along other-side peripheral edge 914 flows along flow path 744 provided between guidance portion 743 and wall 733.

With the above configuration, since flow path 744 is formed between guidance portion 743 and wall 733 that is away from guidance portion 743 to the one side in the width direction by a predetermined distance, it is possible to cause water, which has fallen along other-side peripheral edge 914 of holder 91, to flow along flow path 744.

Further, in carrier plate 32 in the above embodiment, wall 733 includes inclined surface 734 that is inclined toward a side of guidance portion 743. Thus, in a case where water that has fallen along other-side peripheral edge 914 of holder 91 reaches wall 733, inclined surface 734 guides the water to the side of guidance portion 743, and thus, it is possible to cause the water, which has fallen along other-side peripheral edge 914, to flow to guidance portion 743.

Further, carrier plate 32 in the above embodiment further includes bead portions 741 and 742 on a side of attachment portion 73, which is opposite to a side of attachment portion 73 on which wall 733 is provided. Bead portions 741 and 742 guide downward water that has fallen along one-side peripheral edge 913 of holder 91, which is opposite to other-side peripheral edge 914 of holder 91. Thus, it is possible to cause water, which has fallen along one-side peripheral edge 913, to flow along a predetermined path.

Further, in carrier plate 32 in the above embodiment, one end of bead portion 742 extends toward guidance portion 743, and joining region 731c is formed at an outlet of flow path 744 formed between wall 733 and guidance portion 743. Joining region 731c is partially surrounded by a leading-end portion of bead portion 742, wall 733, and guidance portion 743, allows water flowing out from flow path 744 and water guided by bead portion 742 to join in joining region 731c, and causes the joined water to flow downward along guidance portion 743 from between the leading-end portion of bead portion 742 and guidance portion 743. Thus, it is possible to allow water flowing along bead portion 742 and water flowing through guidance portion 743 to join in joining region 731c. Further, it is possible to drain water easily and effectively by configuring, while maintaining the force of water traveling through flow path 744, a drainage path for water flowing along bead portion 742 from the one side in the width direction in the same manner as flow path 744. Further, since joining region 731c is provided in the down direction from wall 733 and toward the other side in the width direction, it is not necessary to change the disposition of lowering-side end holder 81 or the like, and the layout of lowering-side end holder 81 or the like is facilitated.

Further, in carrier plate 32 in the above embodiment, notch 745 is formed by cutting out an upstream-side part of flow path 744 formed between wall 733 and guidance portion 743. Thus, water that has fallen along other-side peripheral edge 914 of holder 91 moves along notch 745 to the upstream side of flow path 744 and passes through flow path 744, and thus, it is possible to cause the water, which has fallen along other-side peripheral edge 914, to flow along flow path 744.

Further, in carrier plate 32 in the above embodiment, upper-side edge portion 32d of attachment portion 73, which is an edge portion on a side on which the window glass is attached, includes inclined surface 800 inclined toward the side on which guidance portion 743 is provided. Thus, it is possible to cause water, which has fallen along the surface of holder 91, to flow along the predetermined path formed by bead portions 741 and 742, and guidance portion 743. Further, even when carrier plate 32 rotates with guide rail 31 as an axis, the attachment of holder 91 is facilitated.

Further, in carrier plate 32 in the above embodiment, upper-side edge portion 32d includes a flat surface on which a part of holder 91 is placed. Thus, carrier plate 32 can stably support holder 91.

Further, in carrier plate 32 in the above embodiment, upper-side edge portion 32d includes surface 801 that substantially perpendicularly intersects the above flat surface on one side of surface 801 and intersects inclined surface 800 on the other side of surface 801. Thus, it is possible to guide the bottom portion of holder 91 to a predetermined position of attachment portion 73 of carrier plate 32 more smoothly via inclined portion 800 while preventing the area of the flat surface of upper-side edge portion 32d and the area of inclined portion 800 from being reduced.

While a preferred embodiment of the present invention has been described above, the present invention is not limited to the embodiment described above, but various changes are possible without departing from the spirit of the present invention. In particular, a plurality of embodiments and variations described herein may be arbitrarily combined as needed.

### Industrial Applicability

The present invention is applicable to a window regulator for driving a window glass of an automobile up and down.

### Reference Signs List

1 Window regulator
31 Guide rail
32 Carrier plate
320 Carrier plate
32a Main body
32b Surface
32c Surface
32d Upper-side edge portion
32e Lower-side edge portion
32f One-side edge portion
32g Other-side edge portion
32g1 Edge portion
32g11 End
32g12 Side edge
32g2 Edge portion
32g3 Edge portion
33 Raising-side cable
33a End
34 Lowering-side cable
34a End
35 Driving section
37 Base portion
38a Sidewall portion
38b Sidewall portion
39a Flange portion
39b Flange portion
45 Upper cable guide
51 Drum housing
51a Main body
56 Driving motor
57 Raising-side cable lead-out groove
59 Lowering-side cable lead-out groove
71 Attachment portion
711 Wall
711a Hole
711a1 Upper-side peripheral edge
711a2 Lower-side peripheral edge
711a3 One-side peripheral edge
711a4 Other-side peripheral edge
711b Hole
712 Wall
7121 Upper-side peripheral edge
7122 Lower-side peripheral edge
7123 One-side peripheral edge
7124 Other-side peripheral edge
713 Wall
714 Wall
721 Bead portion
722 Bead portion
73 Attachment portion
731 Wall
731a Hole
731b Hole
731c Joining region
732 Wall
733 Wall
7331 End
7332 End
734 Inclined surface
741 Bead portion
742 Bead portion
7421 End
743 Guidance portion
744 Flow path
745 Notch
746 Outlet formation portion
747 Outlet formation portion
75 Guide groove
77 Rotation prevention claw
78 Elastic claw
79 Raising-side end holder
81 Lowering-side end holder
85 Coil spring
87 Coil spring
91 Holder
800 Inclined portion
801 Surface
911 Upper-side peripheral edge
912 Lower-side peripheral edge
913 One-side peripheral edge
914 Other-side peripheral edge

1. A carrier plate to which a window glass is attached via a holder and which slides on or along a guide rail, the carrier plate comprising:
an attachment portion to which the holder is attached;
a guidance portion that is provided on one side of the attachment portion and guides water downward, the water having fallen along a one-side edge of the holder; and
a wall that is provided in a position away from the guidance portion toward a region by a predetermined distance and regulates an attachment position of the holder, the region being a region in which the holder is attached, wherein
the carrier plate is configured such that the water that has fallen along the one-side edge of the holder flows between the guidance portion and the wall.

2. The carrier plate according to claim 1, wherein
the wall includes an inclined surface that is inclined toward a side of the guidance portion.

3. The carrier plate according to claim 1, further comprising:
a bead portion on a side of the attachment portion, the bead portion guiding water downward, the side of the attachment portion being opposite to a side of the attachment portion on which the wall is provided, the water having fallen along an other-side edge of the holder, the other-side edge being opposite to the one-side edge of the holder.

4. The carrier plate according to claim 3, wherein
one end of the bead portion extends toward the guidance portion, and
a joining region is formed at an outlet of a flow path formed between the wall and the guidance portion, the joining region being partially surrounded by a leading-end portion of the bead portion, the wall, and the guidance portion, allowing water flowing out from the flow path and water guided by the bead portion to join in the joining region, and causing the joined water to flow downward along the guidance portion from between the leading-end portion of the bead portion and the guidance portion.

5. The carrier plate according to claim 1, wherein
a notch is formed by cutting out an upstream-side part of a flow path formed between the wall and the guidance portion.

6. The carrier plate according to claim 1, wherein
an edge portion of the attachment portion includes an inclined surface inclined toward the side on which the guidance portion is provided, the edge portion being an edge portion on a side on which the window glass is attached.

7. The carrier plate according to claim 6, wherein
the edge portion includes a flat surface on which a part of the holder is placed.

8. The carrier plate according to claim 7, wherein
the edge portion includes a surface that substantially perpendicularly intersects the flat surface on one side of the surface and intersects the inclined surface on another side of the surface.

9. A window regulator comprising the carrier plate according to claim 1.
